(19) United States
(12) Patent Application Publication
(10) Pub. No.: US 2023/0378837 A1
(43) Pub. Date: Nov. 23, 2023

(54) STATOR FOR A ROTARY ELECTRIC MACHINE, METHOD FOR PRODUCING THE STATOR, AND ROTARY ELECTRIC MACHINE

(71) Applicant: Schaeffler Technologies AG & Co. KG, Herzogenaurach (DE)

(72) Inventor: Holger WITT, Bühl (DE)

(73) Assignee: Schaeffler Technologies AG & Co. KG, Herzogenaurach (DE)

(21) Appl. No.: 18/030,790

(22) PCT Filed: Sep. 28, 2021
(86) PCT No.: PCT/DE2021/100782

§ 371 Date: Apr. 7, 2023

(30) Foreign Application Priority Data
Oct. 7, 2020 (DE) 10 2020 126 244.2

(51) Int. Cl. H02K 3/28; H02K 21/24; H02K 15/04

(52) U.S. Cl. CPC H02K 3/28; H02K 21/24; H02K 15/0478

(57) ABSTRACT

A stator for a rotary electric machine, a method for producing the stator, and the rotary electric machine. The stator has a body with a plurality of stator teeth arranged in a circumferential direction; grooves between the stator teeth; and conductor sections, arranged in the grooves, of at least one conductor pair which forms at least a portion of windings. In each groove, conductor sections are arranged along the groove depth parallel to and offset from one another and the sequence of the arrangement of the parallel conductor sections in each groove alternates in the circumferential direction. The conductors of the conductor pair, deviating from a winding direction extending basically circumferentially, meander in a radial direction, and via an enlacement formed thereby in each case, enlace around one group of stator teeth. The stator enables a high power density and a high degree of efficiency along with low installation space requirements.

### CROSS-REFERENCE TO RELATED APPLICATIONS

This application is the U.S. National Phase of PCT Appln. No. PCT/DE2021/100782, filed Sep. 28, 2021, which claims the benefit of German Patent Appln. No. 102020126244.2, filed Oct. 7, 2020, the entire disclosures of which are incorporated by reference herein.

### TECHNICAL FIELD

The disclosure relates to a stator for a rotary electric machine, in particular for an axial flux machine, a method for producing the stator, and the rotary electric machine itself.

### BACKGROUND

The electric drive train of motor vehicles is known from the prior art. It consists of components for energy storage, energy conversion and energy transmission. The components for energy conversion include radial flux machines as well as axial flux machines.

However, radial flux machines often have only one operating point where they have the best degree of efficiency. Accordingly, they are not designed to adjust the operating point depending on the changing requirements placed on them and thus to achieve the highest efficiency according to the different requirements of the different operating parameters or at different operating points.

In order to overcome this disadvantage, rotary electric machines adapted to the occurring requirements with regard to their operating range are often used, or the mentioned disadvantage is compensated by coupling the rotary electric machine to a transmission unit or integrating a transmission unit into the rotary electric machine, as for example in the case of an electric axle.

Axial flux machines are known in the prior art in various designs with one or more stators and one or more rotors.

An electric axial flux machine is a motor or generator in which the magnetic flux between a rotor and a stator is implemented parallel to the axis of rotation of the rotor.

Such an axial flux machine can be designed according to different types which differ in the arrangement of rotor and/or stator, and realize different special features and advantages in the application, e.g. as a traction machine for a vehicle.

Axial flux machines exist with different winding forms. A common winding form is the single-tooth winding. Single-tooth windings form only small winding heads, but generate a magnetic field with a high portion of harmonics, i.e. waves with a different frequency than the number of revolutions of the rotor of the axial flux machine, which negatively affect the acoustics and the degree of efficiency. Axial flux machines with distributed windings offer the advantage that the aforementioned disadvantages do not occur or occur only to a limited extent. However, the winding heads of these distributed windings require more installation space in the axial and/or radial direction.

Especially in axial flux machines, large winding heads are not desirable, since they limit the maximum diameter of the active components in the case of radial expansion, which reduces the maximum torque that can be made available. A relatively large axial expansion of the winding heads causes a larger, also undesirable axial installation length of the entire rotary electric machine.

Specific embodiments are discussed below to explain the prior art.

U.S. Pat. No. 6,348,751 B1 discloses an electric motor with active hysteresis control of winding currents and/or with efficient stator winding arrangement and/or adjustable air gap to form an axial flux machine. In a plurality of segments, a stator of this electric motor comprises a plurality of stator teeth which are enlaced in a serpentine manner with corresponding segments of windings, executed in a plurality of planes. Each phase occupies a respective circumferential region of the stator.

US 2003/0189388 A1 discloses an assembly having an axial flux machine comprising a stator and a rotor. The stator has a plurality of axially aligned stator teeth that are separated by grooves. Windings of a stator winding run around the stator teeth. It can be seen that the winding heads have a relatively large volume requirement in the axial and/or radial direction.

US 2019/0252930 A1 relates to a stator arrangement for an axial flux machine, and to an axial flux machine having such a stator arrangement. The stator arrangement comprises a stator having a plurality of stator teeth which are arranged concentrically distributed in the circumferential direction and separated from a rotor by an air gap in the axial direction, wherein the stator teeth comprise two opposing end portions in the axial direction and a tooth core between the end portions, and wherein each tooth core has a core cross-sectional area and is wound with at least one coil winding. Single-tooth windings are provided here accordingly.

### SUMMARY

On this basis, the present disclosure is based on the object of providing a stator of a rotary electric machine, a method for the production thereof, and the rotary electric machine equipped therewith, which enable a high power density and a high degree of efficiency to be combined with low installation space requirements for the winding heads.

This object is achieved by the stator of a rotary electric machine, by the method for producing a stator of a rotary electric machine, and by the rotary electric machine having one or more of the features described herein.

Advantageous embodiments of the stator are provided below and in the claims.

The features of the claims can be combined in any technically useful manner, wherein the explanations from the following description as well as features from the figures can also be consulted for this purpose, which comprise supplementary embodiments of the disclosure.

The disclosure relates to a stator of a rotary electric machine, comprising a stator body, which has a plurality of stator teeth arranged in a circumferential direction and grooves formed between the stator teeth. Arranged in the grooves are conductor sections of at least one conductor pair which forms at least a portion of windings of the stator, wherein, in each groove, conductor sections of the conductor pair are arranged along the depth of the groove so as to be parallel to and offset from one another and the sequence of the arrangement of the parallel conductor sections in each groove, through which the conductors run, alternates in the circumferential direction. The conductors of the conductor pair, deviating from a winding direction extending basically in the circumferential direction, meander in a radial direction in a direction extending substantially perpendicular to the circumferential direction, wherein they, by means of an enlacement formed thereby in each case, enlace around one group of stator teeth.

In particular, the rotary electric machine is designed as an axial flux machine.

The perpendicular direction can also be understood as a direction of 60°-120° with respect to an ideal tangent to the circumferential direction. In addition, the course in this direction can also be curved or designed with at least a slight kink.

The stator body can also be referred to as the stator yoke, on which a plurality of axially projecting stator teeth are arranged. Such a stator carrier can be formed from the same laminated core as the stator teeth, or alternatively can be a plastic carrier on which the stator teeth are arranged.

The two conductors of a conductor pair, which are connected to a respective phase, are designed to have a different polarity originating from a common connecting region. Along the general winding direction, originating from the common connecting region, one of the conductors of the conductor pair can thus be designated as the positive conductor and the respective other conductor of the conductor pair as the negative conductor.

This means that the conductors of a conductor pair connected to a respective phase together form a so-called double layer. Along the circumferential direction of the stator, in each groove through which the two conductors run, the sequence of arrangement changes along the depth of the groove. A respective conductor pair follows along a plurality of stator tooth groups in a winding direction extending basically in the circumferential direction.

The depth of the groove is to be measured from the free end of the stator tooth to the bottom of the groove in the region of attachment of the stator tooth to a load-bearing element or in the region of the transition of the stator tooth to a load-bearing region. For an axial flux machine in an I arrangement, the depth of the groove must be determined accordingly in the axial direction.

In an axial flux machine, this means that the conductors meander or serpentine in the radial direction, and that in a first groove the first conductor is arranged axially furthest out on the stator tooth, and the second conductor is arranged axially further in. At the next groove traversed by the two conductors, the second conductor is arranged axially furthest out on the stator tooth, and the first conductor is arranged axially further in.

The fact that the conductors of a respective enlacement formed in this way each enlace a group of stator teeth means that an enlacement encloses a plurality of stator teeth, wherein grooves located between the enlaced or enclosed stator teeth are not traversed by the conductors forming the respective enlacement.

Due to the parallel arrangement of the conductor sections in the grooves, they are arranged in different layers or planes if the rotary electric machine is designed as an axial flux machine. Due to the alternating sequence, this arrangement of conductor sections per groove changes from layer to layer. For example, a first conductor section can be arranged in a first groove in a first layer and a second conductor section can be arranged in said first groove in a second layer, and in a next groove in the circumferential direction in which the conductor pair runs, the first conductor section can be arranged in the second layer and the second conductor section can be arranged in said next groove in the first layer.

In an advantageous embodiment, the conductors of the conductor pair are designed to have current flowing through them in different circumferential directions, wherein a respective conductor of the conductor pair enlaces the group of stator teeth on different radial sides so that the current flow occurs in a respective common groove in both conductors along the same direction.

In an axial flux machine, this means that, for example, a first conductor of the conductor pair enlaces the group of stator teeth after passing through a first groove on the radially inner side of the group of stator teeth, and a second conductor of the conductor pair enlaces the same group of stator teeth after passing through the first groove on the radially outer side of the group of stator teeth.

After passing through a next groove associated with this conductor pair in the circumferential direction, the first conductor of the conductor pair enlaces the next group of stator teeth on the radially outer side of the group of stator teeth, and the second conductor of the conductor pair enlaces the same next group of stator teeth on the radially inner side of the group of stator teeth.

Here, the conductors run along a general winding direction defined along the circumferential direction of the stator.

This means that the conductors of a conductor pair only run together in the grooves in sections. Outside of the grooves, the conductors of the respective conductor pair run in different regions on the stator teeth.

The two conductors of a conductor pair, which are connected to a respective phase, are designed to have a different polarity originating from a common connecting region. Along the general winding direction, originating from the common connecting region, one of the conductors of the conductor pair can thus be designated as the positive conductor and the respective other conductor of the conductor pair as the negative conductor.

The current flow direction can be defined, for example, from the positive to the negative voltage pole. Because the current flow in a respective common groove in both conductors runs along the same direction, the current effects of the two conductors add up to cause a torque on a rotor associated with the stator.

Furthermore, the stator can be designed for an n-phase rotary electric machine, wherein the stator has n conductor pairs, which are connected to one of the n phases each. Only conductor sections of one of the n phases are arranged in a respective groove, wherein the conductors of the conductor pair enlace a group of n stator teeth.

The conductors of the respective conductor pair enlace the group of n stator teeth on different radial sides.

It is not excluded that several conductor pairs of the same phase are arranged in the same groove as well. This also means that the conductor sections of the n conductor pairs are arranged so as to be offset by an angle value in the grooves on the circumference.

Alternatively, the stator can be designed in such a way that conductor pairs of different phases are arranged in the same groove.

In a further advantageous embodiment, the conductor sections of a plurality of windings of at least one conductor pair are arranged in a respective groove.

A winding refers to a region of a conductor that runs once around the circumference. For example, two windings of a conductor pair can be arranged in a groove. A winding of a conductor pair can be referred to as a double layer, wherein a respective conductor of a double layer is referred to as a layer or runs in a layer. Accordingly, two windings of a conductor pair in a groove can be referred to as two double layers.

A respective conductor pair is designed according to the claimed embodiments.

In particular, the windings can be arranged side by side along the depth of the groove so as to be parallel to and offset from one another.

In this case, the sequence of arrangement of the conductor sections, in the case of an axial flux machine in the axial direction, continues in a respective groove, even if several windings are completed. This means that a first section of a sequence in the first layer in the groove and second conductor section in the second layer in the second layer in a first winding, this order is implemented also in the second winding in the same groove.

Accordingly, the reversal of the sequence of arrangement of the conductor sections in the nearest groove in the circumferential direction associated with the concerned phase is also implemented for the second winding.

An advantageous embodiment provides that a transition between the windings of the conductors is implemented by transition sections of the conductors, each having a circumferential length corresponding substantially to the distance, also to be measured along the circumferential direction, between two adjacent grooves in which a conductor extends.

The transition section can also be referred to as a layer jump. The transition section or the layer jump makes it possible, for example in an axial flux machine, for the windings of the conductors of the concerned conductor pair to run substantially in planes aligned perpendicular to an axis of rotation of a rotor which, together with the stator, forms a rotary electric machine, in particular an axial flux machine. The respective transition section or layer jump is a length region of the concerned conductor which runs from such a plane or layer into a further plane extending parallel to the initial plane in order to enable the conductor in this layer to also form a winding in a plane aligned perpendicular to the axis of rotation.

For example, the transition section or layer jump can be formed as only one of the radially outer enlacements or the radially inner enlacements of a group of stator teeth.

The transition section of a conductor can extend into an adjacent plane of the conductor arrangement after a winding is completed.

With an alternating arrangement of a conductor section of a first conductor in a groove in a first layer or first plane and arrangement of a conductor section of a second conductor in the same groove in a second layer or second plane, when transition sections of the two conductors are connected to the conductor sections in this groove, the first conductor can be arranged in the second plane and the transition section on the first conductor can bring the first conductor into a third plane which is aligned parallel to the first and second planes. Similarly, the second conductor, when it is located in the second plane, can also be guided into the third plane through its transition section. In the third and fourth planes, the two conductors of the conductor pair again run in the grooves in an alternating manner in accordance with the disclosure.

In this regard, the transition sections can be formed in a region of the circumference of the stator, in which the electrical connections of the conductors are also implemented.

Due to this, there is only a very small volume requirement for the implementation of the transition of the conductors, in the case of an axial flux machine along the axial extension of the stator teeth.

In particular, at least the length sections of the conductors which enlace a group of n stator teeth can be made without welding conductor elements to form the length sections.

The guidance of the conductors according to the disclosure makes it possible to design or wind them without connecting welds.

According to a further aspect, the disclosure relates to a method for producing a stator of a rotary electric machine according to the disclosure, wherein a stator body having a plurality of stator teeth arranged in a circumferential direction and grooves formed between the stator teeth, and at least one conductor pair are provided and conductor sections of the at least one conductor pair are arranged in the grooves, so that the conductor pair forms at least a portion of windings of the stator. In a respective groove, conductor sections of the conductor pair are arranged along the depth of the groove so as to be parallel to and offset from one another such that the sequence of the arrangement of the parallel conductor sections in each groove, through which the conductors run, alternates in the circumferential direction. In this regard, the conductors of the conductor pair are arranged in such a way that they, deviating from a winding direction extending basically in the circumferential direction, meander in a radial direction in a direction extending substantially perpendicular to the circumferential direction and, by means of an enlacement formed thereby in each case, enlace around one group of stator teeth.

Again, the perpendicular direction can also be understood as a direction of 60°-120° with respect to an ideal tangent to the circumferential direction. In addition, the course in this direction can also be curved or designed with at least a slight kink.

One embodiment of a method for producing the winding includes providing a plurality of conductors, and winding the conductors on a first blade along a first winding direction so that the conductors enlace the first blade, and then removing the first blade from the winding of the conductor pair produced thereby.

In particular, the method is used for producing a winding for a stator of an axial flux machine.

A respective winding direction runs in a rotation substantially around the longitudinal axis of the first blade.

A further embodiment of a method for producing the winding includes providing a first conductor and a further conductor, bending the two conductors into a zigzag shape at least in lengthwise portions thereof, and moving the further conductor in a combination movement with respect to the first conductor which has a translatory movement component along the longitudinal axis of the further conductor and a rotatory movement component about the longitudinal axis of the further conductor, so that the further conductor winds around an extreme value axis of the first conductor which runs through regions of the first conductor which form extreme values of the zigzag course.

A further aspect of the present disclosure is a rotary electric machine having a rotor as well as at least one stator according to the invention.

In particular, this rotary electric machine is designed as an axial flux machine. The conductors of the phases are connected to corresponding contacts carrying current of the respective phase, in particular in a star connection.

The conductors of the conductor pair have current flowing through them in different circumferential directions, wherein a respective conductor of the conductor pair enlaces the group of stator teeth on different sides so that the current flow occurs in a respective common groove in both conductors along the same direction.

### BRIEF DESCRIPTION OF THE DRAWINGS

The disclosure described above is explained in detail below against the significant technical background with reference to the accompanying drawings, which show preferred embodiments. The disclosure is not limited in any way by the purely schematic drawings, wherein it should be noted that the embodiments shown in the drawings are not limited to the dimensions shown. In the drawings:

FIG. 1: shows an axial flux machine in an I arrangement in a perspective section;

FIG. 2: shows the axial flux machine in an I arrangement in an exploded view;

FIG. 3: shows a stator core in a perspective view;

FIG. 4: shows the stator core with windings;

FIG. 5: shows a winding in a perspective view;

FIG. 6: shows a winding in a frontal view;

FIG. 7: shows a first side view of the winding;

FIG. 8: shows a side view of the winding as illustrated in FIG. 7;

FIG. 9: shows a third side view of the winding;

FIG. 10: shows a sectional view according to the sectional course indicated in FIG. 6;

FIG. 11: shows a conductor element in a double layer, which is designed for two double layers;

FIG. 12: shows the arrangement of individual conductor elements in the winding in the partial representations a) to f);

FIG. 13: shows the arrangement of the positive conductor and negative conductor;

FIG. 14: shows the stator core with windings and electrical connections;

FIG. 15: shows blades with a plurality of windings arranged thereon in a perspective view;

FIG. 16: shows blades with a plurality of windings arranged thereon in a top view;

FIG. 17: shows blades with two windings arranged thereon in a perspective view;

FIG. 18: shows blades with two windings arranged thereon in a top view;

FIG. 19: shows the created windings in a perspective view;

FIG. 20: shows the created windings in a top view;

FIG. 21: shows the blades with windings in a front view;

FIG. 22: shows a blade with windings in a view from the side;

FIG. 23: shows a blade with windings in a top view;

FIG. 24: shows the created windings in a view from the side;

FIG. 25: shows the created windings in a top view;

FIG. 26: shows the created winding;

FIG. 27: shows a conductor element in a perspective view;

FIG. 28: shows the conductor element in a view from the side;

FIG. 29: shows two conductor elements in a perspective view;

FIG. 30: shows a winding in a perspective view;

FIG. 31: shows the winding in a view from the side;

FIG. 32: shows a conductor element in a view from the side;

FIG. 33: shows a conductor element in a top view;

FIG. 34: shows two conductor elements connected to one another in a view from the side;

FIG. 35: shows the two conductor elements connected to one another in a top view;

FIG. 36: shows the created winding;

FIG. 37: shows a stator core with winding in a perspective view; and

FIG. 38: shows a stator core with winding in a frontal view.

### DETAILED DESCRIPTION

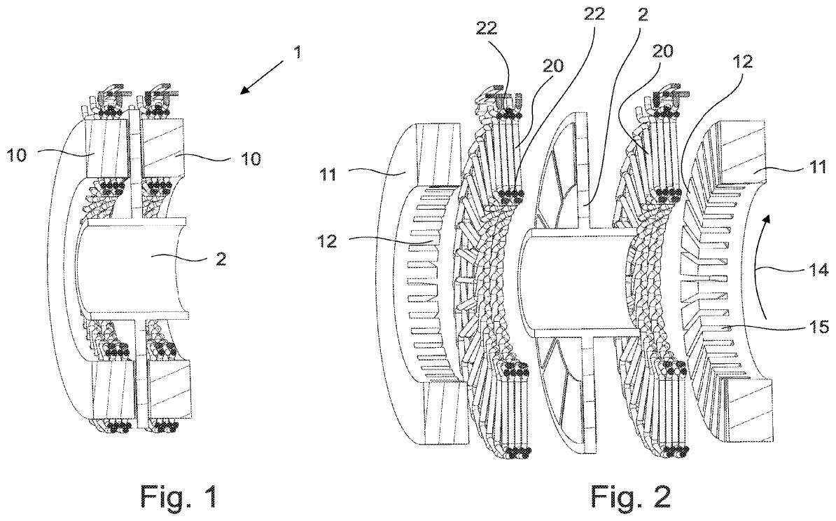

First, the general structure of a stator according to the disclosure is explained with reference to FIGS. 1 and 2.

FIG. 1 shows an axial flux machine in an I arrangement with wave windings in a perspective section, which has a stator 10 each on both sides of a rotor 2. The respective stator 10 comprises a stator body 11 that comprises or forms a stator yoke. On the stator body 11 or comprised on the latter, the stator 10 has a plurality of stator teeth 12 arranged along a circumferential direction 14, which extend in the axial direction. The stator teeth 12 are separated from one another by grooves 15.

In the grooves 15 and enlacing the stator teeth 12, the stator 10 further comprises one or more windings 20 of electrical conductors. These windings are placed on the stator teeth 12 along a general winding direction 21 that runs along the circumferential direction 14.

On the radially inner side of the stator teeth 12 as well as on their radially outer side, the windings 20 form winding heads 22.

FIG. 2 shows the same structure as FIG. 1, but in an exploded view. The rotor 2 is arranged centrally between two stators 10, wherein each stator 10 has a winding 20 which is designed as a wave winding.

However, the present disclosure is not limited to the design of an axial flux machine shown; it can also be designed as an H-type, or one-sided axial flux machine with only one stator and only one rotor.

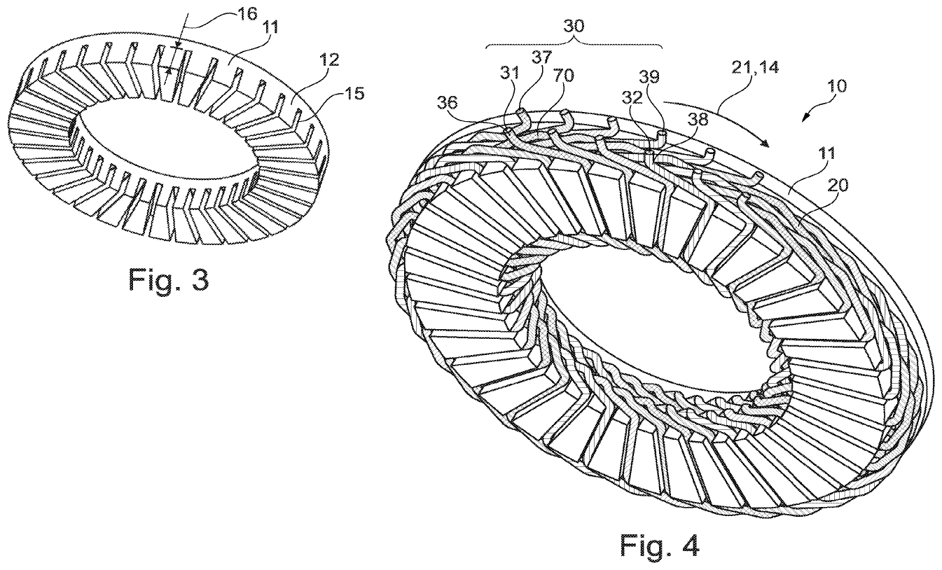

FIG. 3 shows a perspective view of a stator body 11. The grooves 15 and their depth 16 are clearly visible.

As FIG. 4 illustrates, the design of the stator according to the disclosure provides that arranged in the grooves 15 are conductor sections 33 of at least one conductor pair 30 which forms at least a portion of windings 20 of the stator, wherein, in each groove 15, linear conductor sections 33 of the conductor pair 30 are arranged along the depth 16 of the groove 15 so as to be parallel to and offset from one another and the sequence of the arrangement of the parallel conductor sections 33 in each groove 15, through which the conductors run, alternates in the circumferential direction 14.

A conductor pair is illustrated in FIG. 4 by the first conductor 31 and the second conductor 32.

In deviation from the embodiment shown here, the linear conductor sections 33 can also be designed to be curved or saber-shaped. For the sake of conceptual clarity, however, conductor sections formed in this way will also be subsumed under the term “linear conductor sections” in the following.

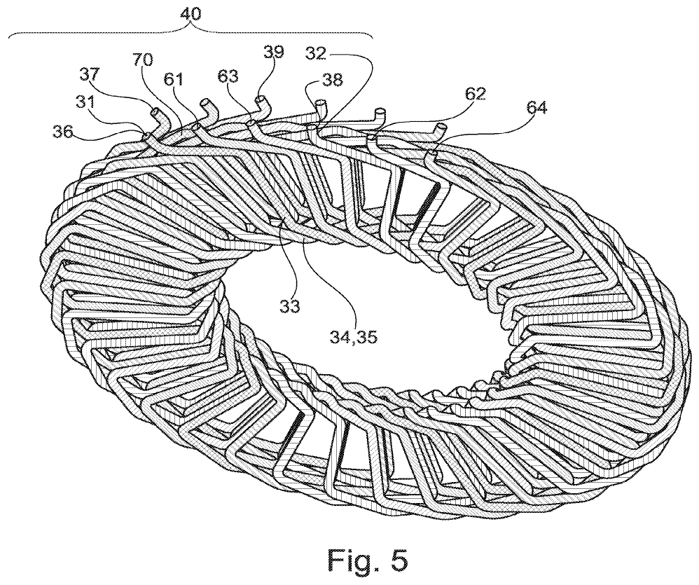

FIG. 4 shows that the conductors of the conductor pair 30 of the wave winding shown meander in a direction perpendicular to the circumferential direction 14 or in a radial direction, deviating from the winding direction 21 extending basically in the circumferential direction 14. This results in the conductors of the conductor pair 30 with enlacements 34 each enclosing a group of stator teeth 12, as illustrated in FIG. 5.

In this regard, current flows through the conductors of the conductor pair 30 in different circumferential directions. This is explained with reference to the first conductor pair 30.

A first conductor 31 of the conductor pair 30 is referred to as a positive conductor for this purpose. A second conductor 32 of the conductor pair 30 is referred to as a negative conductor for this purpose.

The first conductor 31 forms a first connection 36 of the positive conductor and a second connection 37 of the positive conductor.

The second conductor 32 forms a first connection 38 of the negative conductor and a second connection 39 of the negative conductor.

The above conductors are designed to be connected to corresponding three phases, with one positive winding and one negative winding per phase.

A respective conductor 31,32 of the conductor pair 30 enlaces a group 13 of stator teeth 12 on different radial sides so that the current flow occurs in a respective common groove 15 in both conductors 31,32 along the same direction.

It can be seen here that the stator 10 therein comprises not only one conductor pair, but three conductor pairs, wherein a third conductor 61 and a fourth conductor 62 form the second conductor pair, and a fifth conductor 63 and a sixth conductor 64 form the third conductor pair.

However, only sections of conductors of a conductor pair are arranged in a respective groove 15.

In addition, it can be seen from FIG. 4 that the conductors of a conductor pair alternate with respect to the axial sequence in which they are arranged in a groove 15.

To better illustrate the course of the conductors, FIG. 5 shows the created winding package without the stator teeth.

Here, all the conductors are once again clearly visible in a perspective view.

Furthermore, it can be seen that a respective conductor pair 30 encloses a respective group 13 of stator teeth 12, each of which comprises three stator teeth 12.

The alternating arrangement of the conductors of a respective conductor pair 30 in the grooves 15 makes it necessary for these conductors to cross one another. To this end, the conductors form connecting conductor sections 35 which connect the linear conductor sections 35 with one another and ensure that the respective conductor passes back and forth between two arrangement planes between the grooves 15 in which the concerned conductor runs.

For the three phases shown, one phase occupies every third groove 15 in each case.

The axial first conductor layer in a respective groove 15 is occupied by a positive or a negative conductor in an alternating manner in each case. In this regard, a layer can also consist of several discrete individual wires.

In FIGS. 4 and 5, the winding 20 is shown with the formation of two so-called double layers 60. In this context, a double layer 60 refers to the course of a conductor in two planes running parallel to one another. Accordingly, two double layers 60 comprise four planes.

To enable the conductors of the conductor pair 30 to follow this course in the four planes, the conductors form a transition section 70 each, as shown in an exemplary manner by means of the first conductor 31. This transition section 70 allows the first conductor 31 to lead from a second plane to a third plane.

Such a transition section 70 is also referred to as a layer jump.

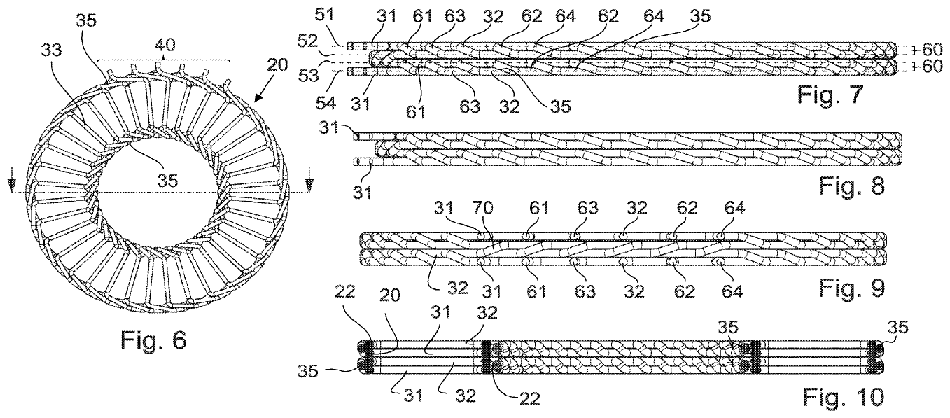

FIG. 6 again shows the implemented winding 20 in a side view. In addition, a common connecting region 40 of the conductors implemented on the circumference is clearly visible.

FIG. 7 clearly shows the arrangement of the conductors 31, 61, 63, 32, 62, 64 and in different planes, namely in a first plane 51, a second plane 52, a third plane 53 and a fourth plane 54.

Furthermore, the connecting conductor sections 35 can be seen here, which ensure that the conductors 31, 61, 63, 32, 62, 64 can change between the first plane 51 and the second plane 52 in each case, and can change between the third plane 53 and the fourth plane 54.

FIG. 8 shows the same winding 20 in the same side view as FIG. 7, only without highlighting of the course of the planes.

FIG. 9 shows a top view of the winding 20 shown in FIG. 6, here the transition sections 70 can be seen which bring the first conductor 31 and the second conductor 32 from the second plane 52 to the third plane 53.

FIG. 10 shows a sectional view according to the sectional course indicated in FIG. 6. Here, too, the connecting conductor sections 35 can be seen in section, which serve to cross the conductors, while at the same time forming a portion of the winding heads 22.

It can also be seen here that the winding heads 22 can be designed in such a way that they are no wider, or only insignificantly wider, than the width of a relevant groove 15 and accordingly have a small axial space requirement.

In addition, however, the winding heads 22 are also designed to be radially flat, so that axial flux machines equipped with them can implement a larger radius in the torque-active region.

This principle for designing a wave winding can also be applied for radial flux machines.

Thus, a winding 20 is shown with two double layers 60 occupying a total of four layers or planes 51,52, 53,54 in the axial direction. An even number of layers or planes is required for this. Since two layers or planes each represent a common structure, two layers belonging to one another are referred to as a double layer 60.

The planes 51,52, 53,54 shown here do not necessarily have to be flat or level. For example, to follow a conical rotor, these planes 51,52, 53,54 could also be designed to be conical.

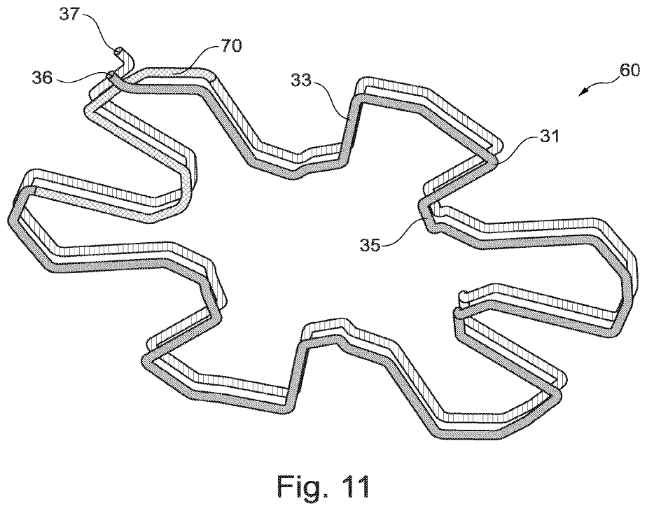

To illustrate a respective conductor run, FIG. 11 shows a single perspective view of the first conductor 31 for one phase in a winding with two double layers. It can be seen that the linear sections 33 are each followed by connecting conductor sections 35, which guide the first conductor 31 back and forth between individual arrangement planes. After completing one revolution, starting from a first connection 36, the first conductor 31 implements a transition section 70 that brings the first conductor 31 axially behind the winding already completed. There, the first conductor again runs in one revolution until it terminates at its second connection 37. The first connection 36 and the second connection 37 are substantially in the same angular range.

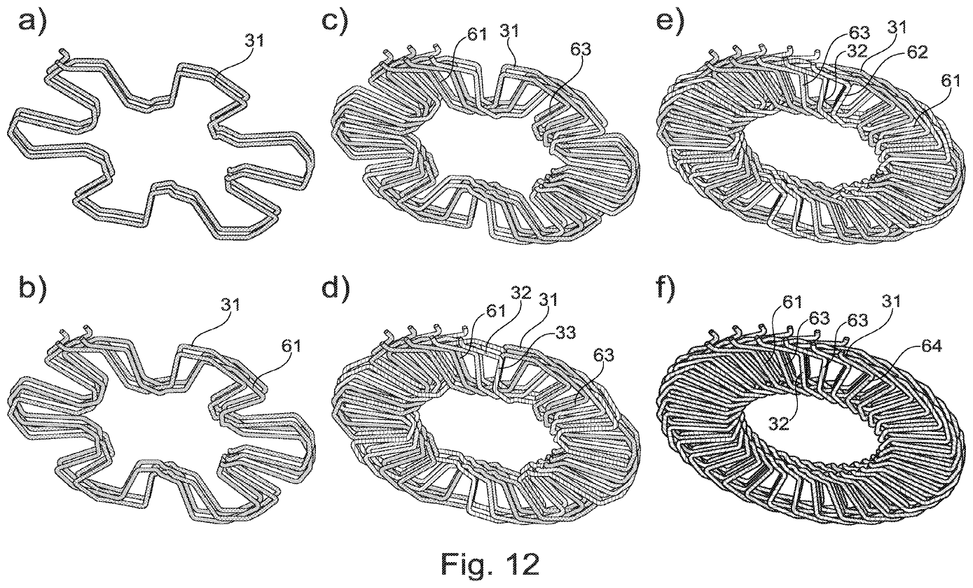

FIG. 12 shows the implementation of the overall winding in 6 partial representations a) to f).

Partial representation a) shows the first conductor 31, as already explained with reference to FIG. 11. Partial representation b) shows the first conductor 31 and a third conductor 61. Partial representation c) shows the first conductor 31, the third conductor 61 and a fifth conductor 63. These conductors all form, for example, a so-called positive conductor of the respective phase. In addition to the conductors shown in partial representation c), partial representation d) now also shows the arrangement of the second conductor 32, which belongs to the same phase as the first conductor 31. As described above, it is also apparent here that linear conductor sections 33 of the first conductor 31 and the second conductor 32 are arranged such that they can be placed together in grooves.

Partial representation e) shows all the conductors already shown in partial representation d) and, in addition, a fourth conductor 62 which, together with the third conductor 61, forms a second conductor pair. Partial representation f) shows all the conductors already shown in partial representation e) and, in addition, a sixth conductor 64 which, together with the fifth conductor 63, forms a third conductor pair. In addition, partial representation f) shows that the winding heads 22 are approximately as wide as the axial length required for the conductors in the grooves.

FIGS. 7 to 10 each show a winding 20 with two double layers 60, but the winding 20 can also consist of only one double layer or have more than two double layers. The second conductor 32, the fourth conductor 62 and the sixth conductor 64 each form the so-called negative conductors.

FIGS. 6 to 10 further show that the linear conductor sections 33, which run in the grooves 15, are each followed by connecting conductor sections 35, which—when the stator is designed in an I arrangement—increase the radial distance to the stator core and at the same time bridge part of the distance to the next groove 15 belonging to the same phase in the circumferential direction, both at the radially inner and at the radially outer winding head 22. Since the linear conductor sections 33 of a double layer to be connected are located on different layers or planes, the connecting conductor section 35 also performs the necessary layer change at the same time.

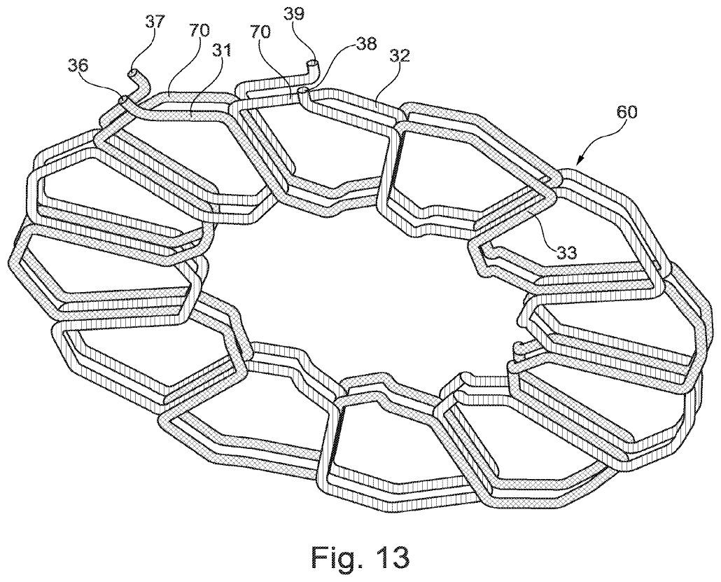

To illustrate a conductor pair 30 further, the course of the first conductor 31 and the second conductor 32 is shown again in FIG. 13. Here it can be seen that the linear conductor sections 33 overlap one another along the axial direction so that they can be shown together in grooves. Furthermore, it can be seen that each of the two conductors 31,32 shown here forms a transition section 70 or layer jump each.

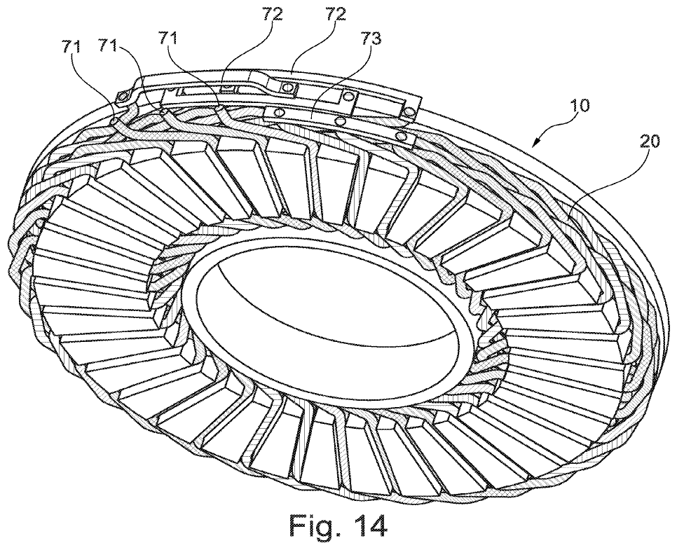

FIG. 14 shows the stator 10 with the winding 20 and a corresponding electrical interconnection.

FIG. 14 shows an advantageous interconnection of the positive and negative windings, resulting in a star interconnection of the windings with three connections for a connection to the power electronics. The phase supply or the connection to the power electronics is made via the first connections of the positive windings, also referred to as positive connections 71. The individual second connections of the positive windings are each connected individually to the second connections of the associated phase of the negative windings. The first connections 73 of the negative windings are connected together to form a star interconnection. This interconnection ensures that the positive and negative windings of a phase are connected in such a way that the conductor pieces in the grooves have the same current direction. Compared to a hairpin winding, where a connection must be produced for the conductor in a groove, the interconnection effort here is reduced to four connection points per phase.

Alternatively, the connection shown can be used for a series interconnection 72. Deviating from the exemplary embodiments shown here, the stator according to the disclosure can also be designed for more or less than 3 phases.

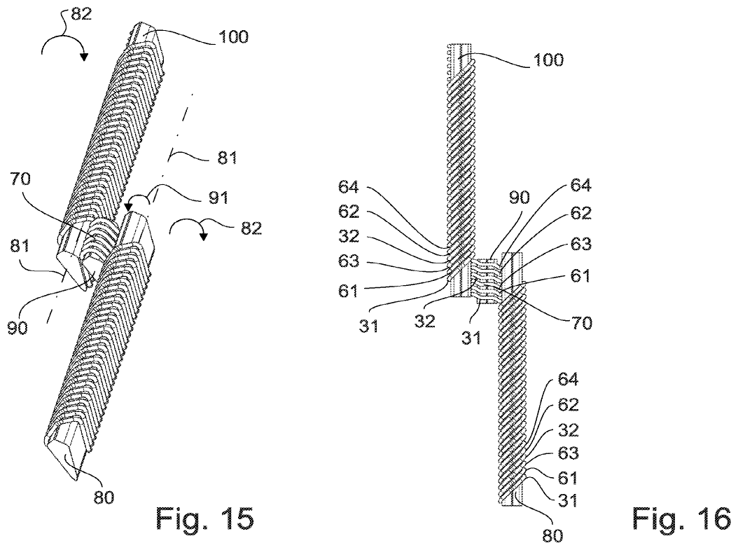

FIGS. 15-26 relate to an embodiment of a method for producing windings of the stator. The method described here refers to the production of windings in two double layers.

To accomplish this, as shown in FIGS. 15-18, a first blade 80, a second blade 90, and a third blade 100 are aligned such that their longitudinal axes extend substantially parallel to one another. The first blade 80 is designed to create windings of a first double layer. The third blade 100 is designed to create windings of a second double layer.

The blades each have a geometry that favors the later method steps of bending into a flattened mat and bending into a circular shape.

As FIGS. 15 and 16 illustrate in different views, the first conductor 31, the second conductor 32, the third conductor 61, the fourth conductor 62, the fifth conductor 63 and the sixth conductor 64 are wound around the first blade 80 along a first winding direction 82, here in a mathematically positive sense. In this regard, it is advisable to rotate the first blade 80 around its longitudinal axis 81 and to shift it such that the following windings are positioned next to existing windings on the first blade 80.

With regard to the conductor pair, which comprises the first conductor 31 and the second conductor 32 and forms the first phase, it should be mentioned that between the first conductor 31 and the second conductor 32 there are still the third conductor 61 and the fifth conductor 63, which, however, belong to the second phase and the third phase.

During the winding process on the first blade 80, the second blade 90 has not yet been moved into position so that it does not interfere with the winding process on the first blade 80. The second blade 90 is not positioned until the required windings have been created on the first blade 80. After the required number of windings has been completed, the second blade 90 is positioned next to the first blade 80 and the winding direction is reversed for about half a revolution. In this way, the conductors are guided via the second blade 90 in a second winding direction 91, which runs opposite to the first winding direction 82.

By reversing the winding direction, the conductors are pre-bent for the layer jump. Thereafter, said conductors are again wound along the first winding direction 82 on the third blade 100, which is positioned after said half reverse rotation. If more double layers are required, the number of blades and windings completed is increased accordingly. If there are more than two layer jumps or transitions between double layers, additional second blades can be used. After the windings have been created, the wound conductors can be compressed into a winding mat so that this winding mat has approximately the same axial extension as the depth of the grooves of the stator body in which the winding or windings are to be accommodated. This winding mat can still be bent into a circular ring shape to facilitate insertion into the grooves of the stator core.

The performance of the method is not necessarily limited to the sequence of the above steps.

For the implementation of a winding mat with only one double layer, the use of the second blade 90 and the third blade 100 can be omitted.

The present method can also be used to produce windings for radial flux machines.

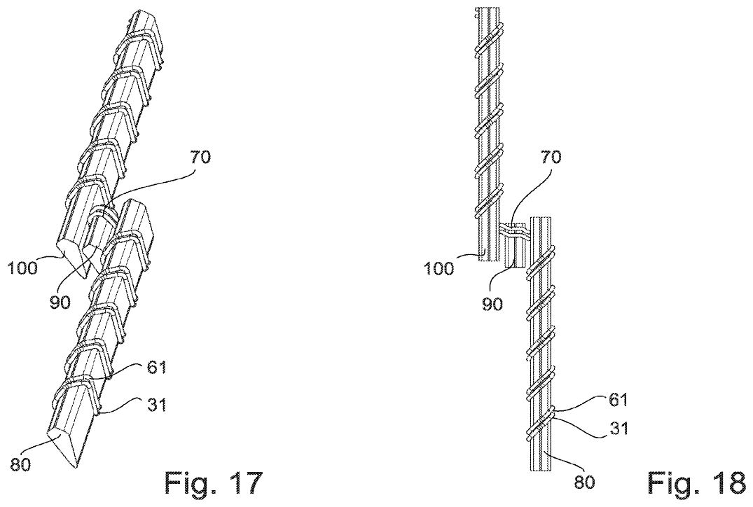

For a simplified explanation of the performance of the method, FIGS. 17 and 18 illustrate the winding processes using only two conductors of 2*n conductors as examples, namely the first conductor 31 and the third conductor 61.

Here it can also clearly be seen that by the enlacement of the second blade 90 with these conductors 31, 61, it forms two transition sections 70.

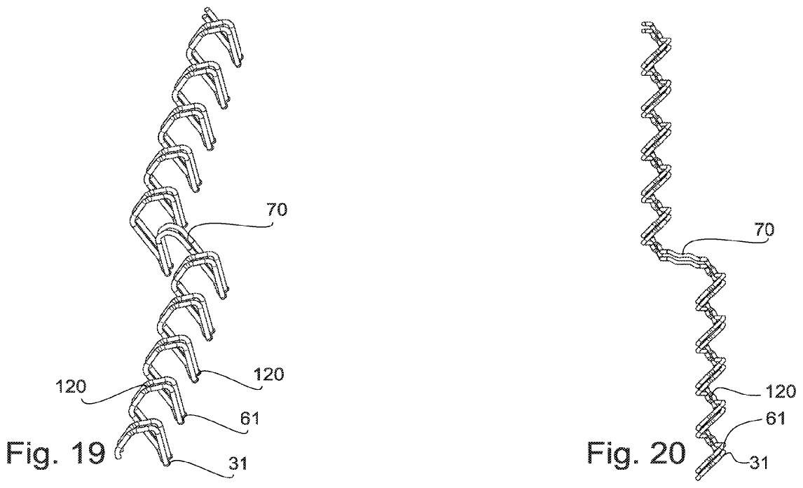

FIGS. 19 and 20 show the created windings 20 after the blades have been pulled out. It can be seen that the winding structure has been retained and the bridging sections 70 have also been formed.

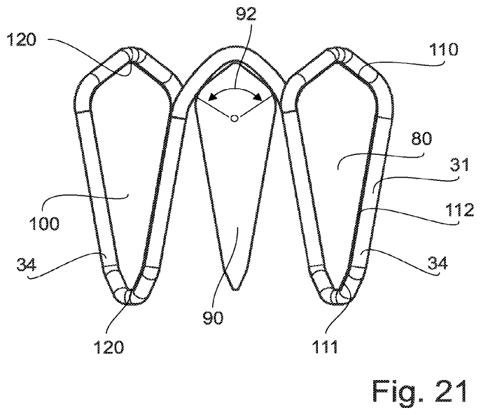

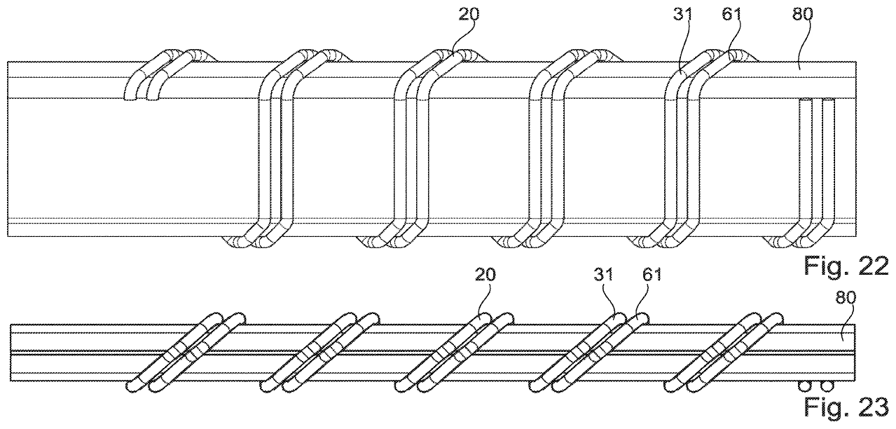

FIG. 21 shows the 3 blades 80,90,100 in a frontal view in the enlacement with the first conductor 31. It can be seen that the first conductor 31 completely enlaces the first blade 80 as well as the third blade 100. However, the second blade 90, which is located between the first blade 80 and the third blade 100, is only enlaced at its upper side at a limited enlacement angle 92. Accordingly, the enlacements of the first blade 80 and the third blade 100 form enlacements on both a first enlacement side 110 and a second enlacement side 111 opposite this first enlacement side 110. On flat lateral surfaces 112 of the blades 80,100, the first conductor 31 is guided substantially linearly.

It can be seen that, equating the created winding with a harmonic oscillation, the first enlacement side 110 forms an extreme value region 120 and the second enlacement side 111 forms an opposite extreme value region 120.

In the opposite extreme value regions 120, the winding is designed with different widths to adapt its shape to the fact that the distance between the grooves in the stator body is greater on the radially outer side than on the radially inner side.

FIGS. 22 and 23 once again show the winding 20 around the first blade 80 in different views.

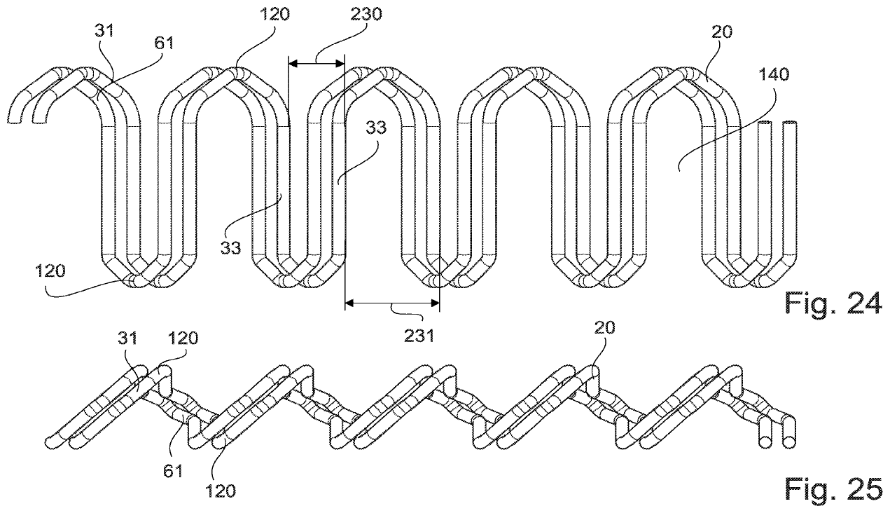

FIG. 24 shows a view of the created winding 20 from the side and FIG. 25 shows the created winding 20 in a top view. FIG. 24 in particular clearly shows the extreme value regions 120 which are formed by the winding 20. Furthermore, it can be seen that each of the two conductors 31,61 forms meshes 140.

It is also apparent here that the spacing of the linear conductor sections 33 within a wave section are spaced apart in an alternating manner by a first distance 230 and a second distance 231, wherein the second distance 231 is greater than the first distance 230. This takes account of the fact that the outer winding heads have to bridge greater distances in the circumferential direction than the inner winding heads. If this method is used for the stator windings of a radial flux machine, the distances for the two winding heads are similar. These possibly change with the radius on which the winding layer lies, in that the successively used blades for the individual double layers are made with correspondingly different widths.

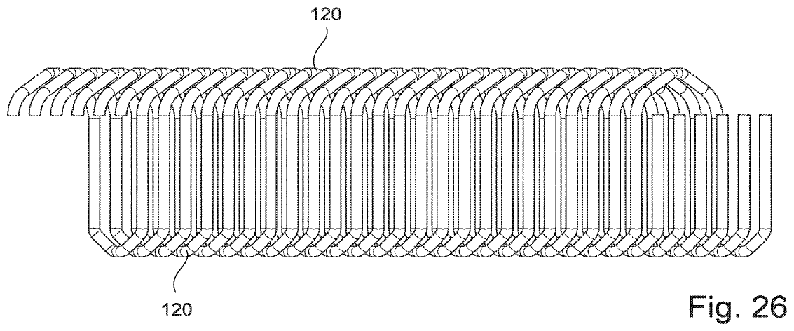

FIG. 26 shows a winding comprising all six conductors forming the three phases.

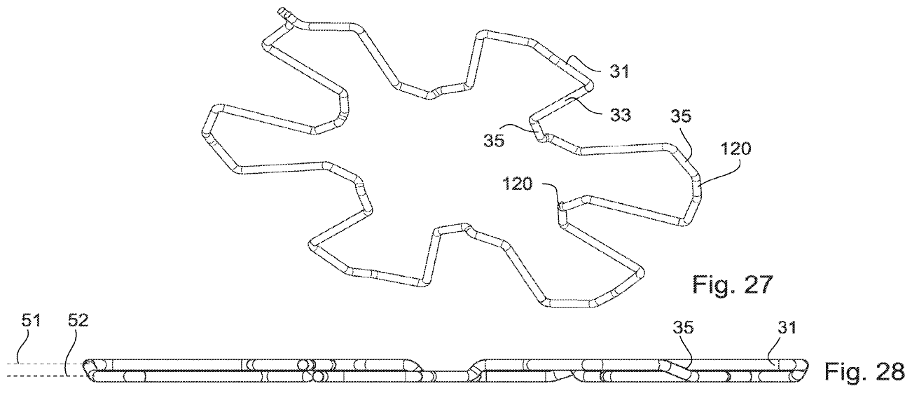

FIGS. 27-38 relate to a further embodiment of the method for producing a winding of the stator.

FIG. 27 exemplarily shows the first conductor 31 in a double layer. Once again, the individual sections of the first conductor 31 can be seen, namely the linear conductor sections 33 as well as also the connecting conductor sections 35 and, in the radially innermost and outermost sections, the extreme value regions 120.

FIG. 28 clearly shows in a side view that the connecting conductor sections 35 ensure that the first conductor 31 runs in an alternating manner between a first plane 51 and a second plane 52.

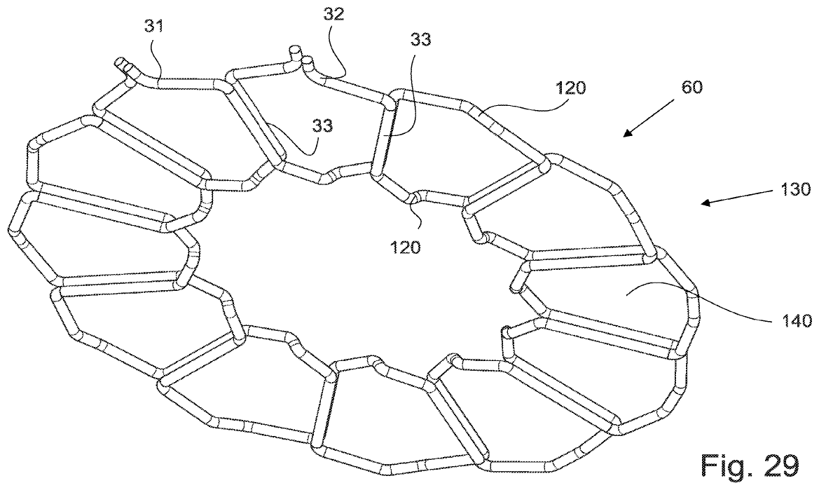

FIG. 29 shows a braid 130 formed by the first conductor 31 and the second conductor 32 so that together they form a positive and a negative phase. These two conductors 31,32 therein form a plurality of meshes 140. It can be seen that both conductors 31,32 are guided alternately in the two arrangement planes. This means that the linear conductor sections 33 of the two conductors 31,32 are arranged alternately axially in front and axially in the rear.

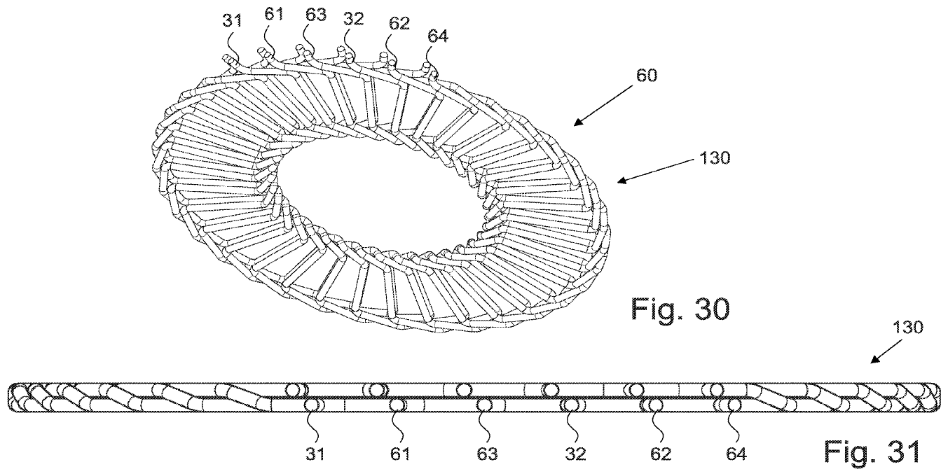

FIG. 30 now shows a braid 130 to which a third conductor 61, a fourth conductor 62, a fifth conductor 63 and a sixth conductor 64 have been added in the manner described for FIG. 29. These six conductors, designed for the connection of three phases, together form a complete double layer.

FIG. 31 shows this braid 130 in a top view.

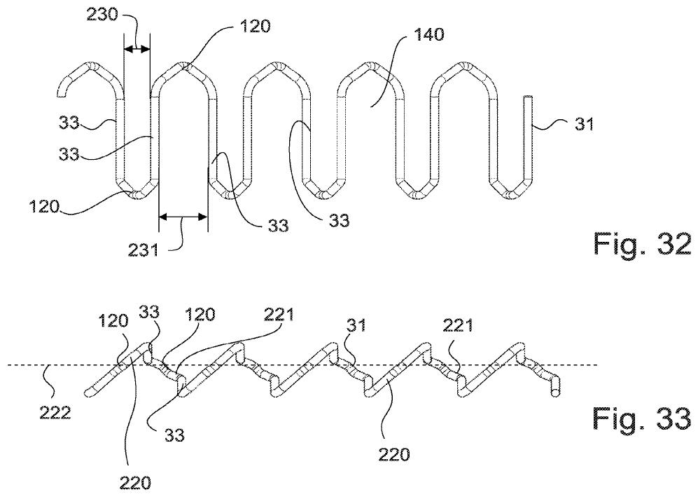

With reference to FIGS. 32-35, the process for producing such a braid will now be explained.

As shown in FIG. 32, a first conductor 31 is first provided, which is present in a meandering or zigzag shape. It can be seen here that a first distance 230 and a second distance 231 are implemented in an alternating manner in each case between adjacent linear conductor sections 33, wherein the second distance 231 is greater than the first distance 230. This results in different widths of the meshes 140 formed as a result, which are open at the top and bottom.

FIG. 33 illustrates that the first conductor 31 shown here, however, meanders not only in one plane, but also in the plane running perpendicular to it, so that the first conductor 31 forms a helical shape or a spatial spiral to some extent. In a practical implementation, this spatial spiral can also be made much flatter than shown in FIG. 33. In the extreme case, the conductor in FIG. 33 is already as flat as after insertion into the grooves of the stator. A central plane 222 passes through the extreme value regions 120. The conductor run in wave or spiral form already has features that favor the subsequent steps for forming it into a winding mat. Thus, the conductor pieces for the later inner winding head are designed shorter/smaller than the conductor pieces for the later outer winding head, so that the distances 230,231 between the conductor pieces for the winding grooves are also different in an alternating manner. The unround shape of the three-dimensional helical shape is formed in such a way that in the subsequent method steps the following flat bending of the braid results in the desired contour, for forming the inner and outer winding heads, as well as the linear conductor sections for the winding grooves.

This means that the zigzag shape is designed to be three-dimensional, wherein when the zigzag shape is equated with a harmonic oscillation, linear conductor sections 33 of the conductor concerned having a positive slope 220 and linear conductor sections of the conductor concerned having a negative slope 221 are respectively arranged on both sides outside a central plane 222 passing centrally through regions of extreme values 120.

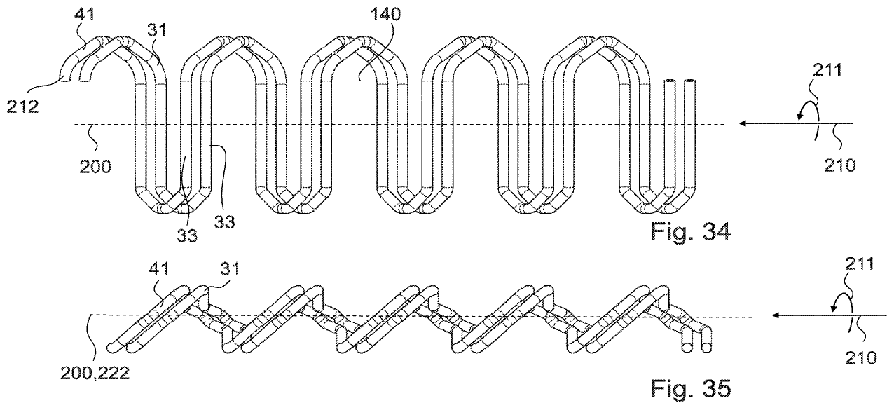

The braid is now created by providing a further conductor 41 of a dual arrangement of conductors, which has been performed in substantially the same manner as the first conductor 31. As indicated in FIGS. 34 and 35, the further conductor 41 is then moved relative to the first conductor 31 with a combination movement combining a translatory movement component 210 with a rotatory movement component 211 so that the further conductor 41 rotates about its longitudinal axis 200 and is simultaneously moved forward along the longitudinal axis 200 so that its conductor tip 212 passes through the wave of the first conductor 31 in each case. As a result, the further conductor 41 snakes through the meshes 140 of the first conductor 31, in a manner similar to producing a wire mesh fence, so that they produce a plurality of spatial spirals twisted into one another.

As can be seen in FIG. 34, the linear conductor sections 33 also alternately overlap one another.

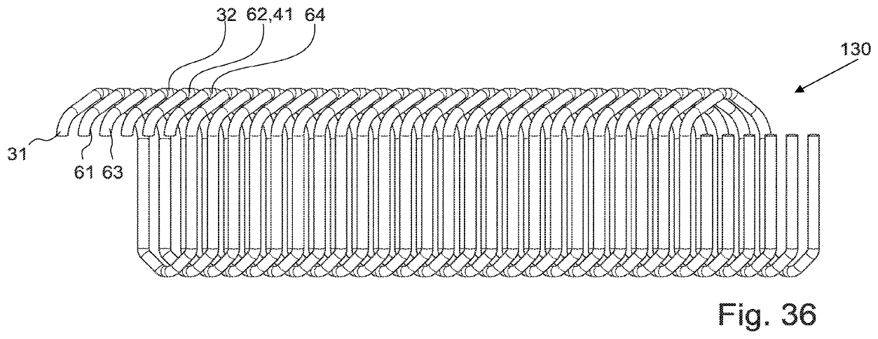

FIG. 36 shows a braid 130 formed by the first conductor 31, a second conductor 32, a third conductor 61, a fourth conductor 62, a fifth conductor 63 and a sixth conductor 64, which have been brought to engage with one another according to the above method. The fourth conductor 62 and the first conductor 31 have been twisted into one another in the manner described. This means that the fourth conductor 62 corresponds to the further conductor 41.

The other conductors shown here, that is, the second conductor 32, the third conductor 61, the fifth conductor 63 and the sixth conductor 64, have again been connected to one another according to the present method in the order shown.

Accordingly, this provides three conductor pairs for connection to three phases, which are intertwined.

In deviation from the embodiment shown here, more or fewer conductor pairs can of course be intertwined to connect the phases.

After producing this braid 130, this braid 130 still needs to be bent into a circular shape. In addition, the three-dimensionally running structures of the individual conductors of this braid can also be reduced in axial extent, so that they produce a flat mat and have a smaller axial space requirement when integrated between stator teeth.

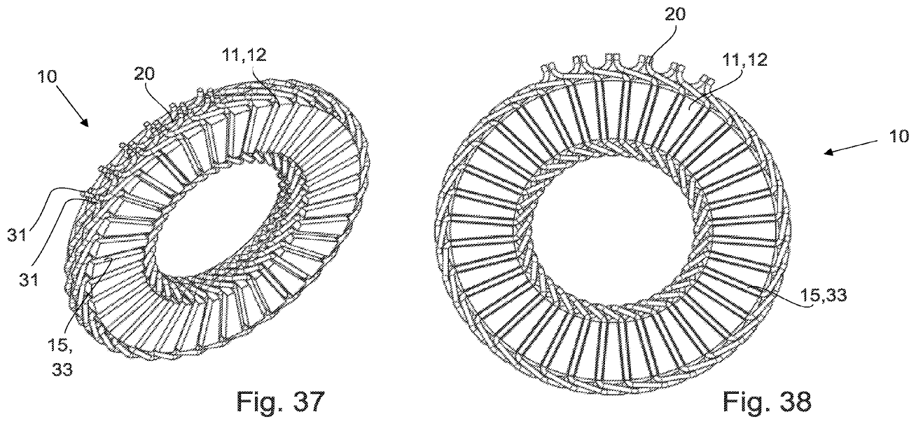

However, the method is not limited to the sequence of individual steps described above. FIGS. 37 and 38 each show a stator 10, in the grooves 15 of which the linear conductor sections 33 of a braid of the six conductors mentioned above are arranged.

The stator 10 shown here has the special feature that it comprises the six conductors in two double layers which, however, are not connected to one another by transition sections as shown in FIG. 5. This is exemplified by the designation of two first conductors 31 in FIG. 37.

The stator according to the disclosure, the method for the production thereof, and the rotary electric machine equipped therewith enable a high power density and a high degree of efficiency to be combined with low installation space requirements for the winding heads.

### LIST OF REFERENCE SYMBOLS

1 Axial flux machine
2 Rotor
10 Stator
11 Stator body
12 Stator tooth
13 Group of stator teeth
14 Circumferential direction
15 Groove
16 Depth of the groove
20 Winding
21 Winding direction
22 Winding head
30 Conductor pair
31 First conductor
32 Second conductor
33 Linear conductor section
34 Enlacement
35 Connecting conductor section
36 First connection of the positive conductor
37 Second connection of the positive conductor
38 First connection of the negative conductor
39 Second connection of the negative conductor
40 Common connecting region
41 Further conductor
51 First plane
52 Second plane
53 Third plane
54 Fourth plane
60 Double layer
61 Third conductor
62 Fourth conductor
63 Fifth conductor
64 Sixth conductor
70 Transition section
71 Positive connections
72 Connection for series interconnection
73 Connection for star interconnection
80 First blade
81 Longitudinal axis
82 First winding direction
90 Second blade
91 Second winding direction
92 Enlacement angle
100 Third blade
110 First enlacement side
111 Second enlacement side
112 Flat lateral surface
120 Extreme value region
130 Braid
140 Mesh
200 Longitudinal axis of the second conductor
210 Translatory movement component
211 Rotatory movement component
212 Conductor tip
220 Section with positive slope
221 Section with negative slope
222 Central plane
230 First distance
231 Second distance

1. A stator of a rotary electric machine, the stator comprising:
a stator body having a plurality of stator teeth arranged in a circumferential direction and grooves formed between the stator teeth;
conductor sections, arranged in the grooves, of at least one conductor pair which forms at least a portion of stator windings;
wherein, in each said groove, the conductor sections of the conductor pair are arranged along a depth of the groove so as to be parallel to and offset from one another and a sequence of an arrangement of the parallel conductor sections in each said groove, through which the conductors run, alternates in a circumferential direction; and
wherein the conductors of the at least one conductor pair, deviating from a winding direction extending basically in the circumferential direction, meander in a radial direction in a direction extending substantially perpendicular to the circumferential direction and, by an enlacement formed thereby in each case, enlace around one group of the stator teeth.

2. The stator according to claim 1, wherein conductors of the at least one conductor pair are designed to have current flowing therethrough in different circumferential directions, a respective one of the conductors of the at least one conductor pair enlaces the group of stator teeth on different radial sides so that the current flow occurs in a respective one of the common grooves in both of the conductors along a same direction.

3. The stator according to claim 1, wherein the stator is configured for an n-phase rotary electric machine, the at least one conductor pair comprises n conductor pairs, which are connected to one of n phases each, only the conductor sections of one of the n phases are arranged in a respective one of the groove, and the conductors of the conductor pair enlace a group of n of the stator teeth.

4. The stator according to claim 3, wherein the conductor sections of a plurality of stator windings of the at least one conductor pair are arranged in a respective one of the grooves.

5. The stator according to claim 4, wherein the stator windings are arranged side by side along the depth of the groove so as to be parallel to and offset from one another.

6. The stator according to claim 3, wherein a transition between the stator windings of the conductors is implemented by transition sections of the conductors, each of the transition sections having a circumferential length corresponding to a distance between two adjacent ones of the grooves in which one of the conductors extends.

7. The stator according to claim 6, wherein the transition section of the conductor extends into an adjacent plane of a conductor arrangement after one of the stator windings is completed.

8. The stator according to claim 3, wherein at least length sections of the conductors which enlace the group of n of the stator teeth are made without welding conductor elements to form the length sections.

9. A method for producing a stator of a rotary electric machine, the method comprising:
providing a stator body having a plurality of stator teeth arranged in a circumferential direction and grooves formed between the stator teeth;
providing at least one conductor pair and arranging conductor sections of the at least one conductor pair in the grooves, so that the at least one conductor pair forms at least a portion of stator windings;
in each groove, arranging conductor sections of the at least one conductor pair along a depth of the groove so as to be parallel to and offset from one another such that a sequence of an arrangement of the parallel conductor sections in each groove, through which the conductors run, alternates in the circumferential direction;
arranging the conductors of the at least one conductor pair such that they, deviating from a winding direction extending basically in the circumferential direction, meander in a radial direction in a direction extending substantially perpendicular to the circumferential direction forming an enlacement in each case; and
enlacing around one group of the stator teeth with the enlacement.

10. A rotary electric machine comprising;
a rotor; and
the stator according to claim 1.

11. A stator for a rotary electric machine, the stator comprising:
a stator body having a plurality of stator teeth arranged in a circumferential direction and grooves formed between the stator teeth;
a conductor pair having conductor sections arranged in the grooves;
wherein, in each said groove, the conductor sections of the conductor pair are arranged along a depth of the groove so as to be parallel to and offset from one another and a sequence of an arrangement of the parallel conductor sections in each said groove, through which the conductors run, alternates in a circumferential direction; and
wherein the conductors of the conductor pair deviate from a winding direction that extends in the circumferential direction and meander in a radial direction that is perpendicular to the circumferential direction to form an enlacement in each case that enlaces around one group of the stator teeth.

12. The stator according to claim 11, wherein the conductors of the conductor pair are configured to have current flowing therethrough in different circumferential directions, a respective one of the conductors enlaces the group of stator teeth on different radial sides so that the current flow occurs in a respective one of the common grooves in both of the conductors along a same direction.

13. The stator according to claim 11, wherein the stator is configured for an n-phase rotary electric machine, there are n conductor pairs, including the conductor pair, which are connected to one of n phases each, only the conductor sections of one of the n phases are arranged in a respective one of the groove, and the conductors enlace a group of n of the stator teeth.

14. The stator according to claim 13, wherein the conductor sections of a plurality of stator windings of the conductor pair are arranged in a respective one of the grooves.

15. The stator according to claim 14, wherein the conductor pair forms at least a portion of stator windings that are arranged side by side along the depth of the groove so as to be parallel to and offset from one another.

16. The stator according to claim 15, wherein a transition between the stator windings of the conductors is implemented by transition sections of the conductors, each of the transition sections having a circumferential length corresponding to a distance between two adjacent ones of the grooves in which one of the conductors extends.

17. The stator according to claim 16, wherein the transition section of one of the conductors extends into an adjacent plane of a conductor arrangement after one of the stator windings is completed.

18. The stator according to claim 13, wherein at least length sections of the conductors which enlace the group of n of the stator teeth are made without welding conductor elements to form the length sections.
